(19) United States
(12) Patent Application Publication
(10) Pub. No.: US 2015/0295883 A1
(43) Pub. Date: Oct. 15, 2015

(54) STORAGE AND RETRIEVAL OF INFORMATION USING INTERNET PROTOCOL ADDRESSES

(71) Applicants: Chandra Sekhar Suram, Secunderabad (IN); Rampullaiah Batchu, Hyderabad (IN); Nitin K. Parikh, Hyderabad (IN); Jyothi Vemulapalli, Secunderabad (IN)

(72) Inventors: Chandra Sekhar Suram, Secunderabad (IN); Rampullaiah Batchu, Hyderabad (IN); Nitin K. Parikh, Hyderabad (IN); Jyothi Vemulapalli, Secunderabad (IN)

(73) Assignee: Freescale Semiconductor, Inc., AUSTIN, TX (US)

(21) Appl. No.: 14/248,354

(22) Filed: Apr. 9, 2014

(51) Int. Cl. H04L 29/12; H04L 29/06

(52) U.S. Cl. CPC H04L 61/2007; H04L 63/0272; H04L 63/0892

(57) ABSTRACT

A method for storing information in a memory using an IP address having numerical fields, where penultimate and ultimate memory banks for the IP address are allocated from the memory. A penultimate pointer is stored in a location of the penultimate memory bank indexed by the value of a penultimate numerical field in the IP address. The penultimate pointer points to the ultimate memory bank. The information is stored in a location of the ultimate memory bank indexed by the value of an ultimate numerical field in the IP address.

### BACKGROUND

The present invention relates generally to Internet communications, and, more particularly, to secured communications over the Internet.

FIG. 1 shows a simplified schematic diagram of one conventional implementation of a virtual private network (VPN) 100. In this implementation, the VPN 100 has ten peers 102(i) (e.g., computer workstations), where 1=1, 2, . . . , 10, and four security gateways 104(j), where j=1, 2, 3, 4. Each peer 102(i) is connected to the Internet 106 via one of the security gateways 104(j), and is uniquely identified by an Internet Protocol (IP) address such as an IP version four (IPv4) address. The IPv4 address may be represented in dot-decimal notation with four numerical fields separated by periods (e.g., a.b.c.d, where a, b, c, and d are octets). Each octet has eight bits for representing values between zero and 255.

Each security gateway 104(j) is a networking device that runs security applications such as Internet Protocol Security (IPsec). To communicate over a network, each security gateway 104(j) establishes an association with a peer security gateway 104(j) (e.g., security gateway 104(1) establishes an association with security gateway 104(2)) known as an IPsec security association. In general, a security association (SA) is a bundle of algorithms and parameters (such as keys) that is used to encrypt and authenticate communications in one direction. SAs may also comprise administrative information such as the amount of data sent for a particular SA, remaining life time of a particular SA, the number of times a particular SA has been renewed, statistics regarding failures of encryption and/or decryption, etc. For communications in two directions, a pair of IPsec SAs is established.

Sometimes, the administrator of the VPN 100 might wish to inquire about the status of an IPsec SA established with a particular peer security gateway. For example, the administrator might want to determine the health of the SA based on some or all of the administrative information described above, or the administrator might simply want to know if a SA exists with the given peer security gateway.

To determine the status of an IPsec SA for a particular peer security gateway 104(j) (e.g., security gateway 104(1) checking the status of the association created with security gateway 104(2)), the corresponding security gateway 104(j) searches for a pointer that identifies the location of the IPsec SA in memory. The pointer, which identifies the address of where the IPsec SA is stored, is maintained in a hash table. The hash table is implemented by a plurality of hash buckets, where each hash bucket is a location in memory that is associated with a hash key and comprises a list. Each list is implemented by a plurality of containers, and each container is a location in memory that stores one element of a list.

To access the pointer, the security gateway 104(j) computes a hash key based on the IPv4 address, a security parameter index (SPI), and (optionally) the security protocol. The security gateway then indexes into the appropriate hash bucket using the hash key, performs a search of the containers in the hash bucket to find the pointer for the IPsec SA, and returns the pointer. It would be advantageous to have a faster way to retrieve IPv4 based IPsec SAs.

### BRIEF DESCRIPTION OF THE DRAWINGS

Embodiments of the present invention are illustrated by way of example and are not limited by the accompanying figures, in which like references indicate similar elements. Elements in the figures are illustrated for simplicity and clarity and have not necessarily been drawn to scale. For example, the thicknesses of layers and regions may be exaggerated for clarity.

FIG. 1 shows a simplified schematic diagram of one implementation of a conventional virtual private network (VPN);

FIG. 2 shows a simplified flow chart of processing that may be performed by a security gateway to store Internet Protocol Security (IPsec) security association information according to one embodiment of the present invention;

FIG. 3 shows a simplified schematic diagram of a memory of a security gateway according to one embodiment of the present invention; and

FIG. 4 shows a simplified flow chart of processing that may be performed by a security gateway to retrieve IPsec security association information according to one embodiment of the present invention.

### DETAILED DESCRIPTION

Detailed illustrative embodiments of the present invention are disclosed herein. However, specific structural and functional details disclosed herein are merely representative for purposes of describing example embodiments of the present invention. Embodiments of the present invention may be embodied in many alternative forms and should not be construed as limited to only the embodiments set forth herein. Further, the terminology used herein is for the purpose of describing particular embodiments only and is not intended to be limiting of example embodiments of the present invention.

As used herein, the singular forms “a,” “an,” and “the,” are intended to include the plural forms as well, unless the context clearly indicates otherwise. It further will be understood that the terms “comprises,” “comprising,” “has,” “having,” “includes,” and/or “including” specify the presence of stated features, steps, or components, but do not preclude the presence or addition of one or more other features, steps, or components. It also should be noted that, in some alternative implementations, the functions/acts noted may occur out of the order noted in the figures. For example, two figures shown in succession may in fact be executed substantially concurrently or may sometimes be executed in the reverse order, depending upon the functionality/acts involved.

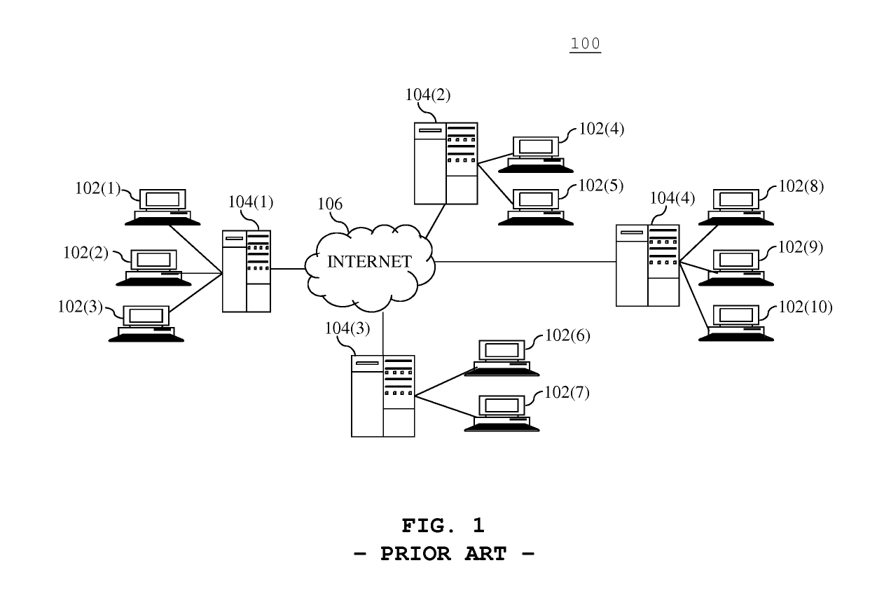

In addition to smaller VPNs such as that shown in FIG. 1, Internet Protocol Security (IPsec) security associations (SAs) are used in larger market segments such as enterprise and carrier market segments. In these larger market segments, there are thousands or millions of peers, and each security gateway establishes IPsec security associations with thousands or millions of peers. In such larger deployments, the hash buckets become relatively large due to the large number of IPsec security associations. As a result, the process of searching a hash bucket for a pointer to an IPsec security association consumes a relatively significant amount of processor cycles that could otherwise be used for packet processing. In fact, if the search becomes too complex, then the performance of the packet processing may be degraded. Thus, there is a need to retrieve IPsec security associations without performing a complex search.

Rather than performing the complex search discussed above, the octets of Internet protocol version four (IPv4) addresses can be used to index directly into memory to retrieve IPsec security association information such as (i) a pointer to the IPsec security association, where the IPsec security association is stored elsewhere in memory, or (ii) the IPsec security association itself. In general, and as will be discussed in further detail below, for a particular IPv4 address, each octet of the IPv4 address is used to index into a different memory bank. The last memory bank indexed (i.e., using the fourth octet of the IPv4 address) comprises a container that stores the IPsec security association information.

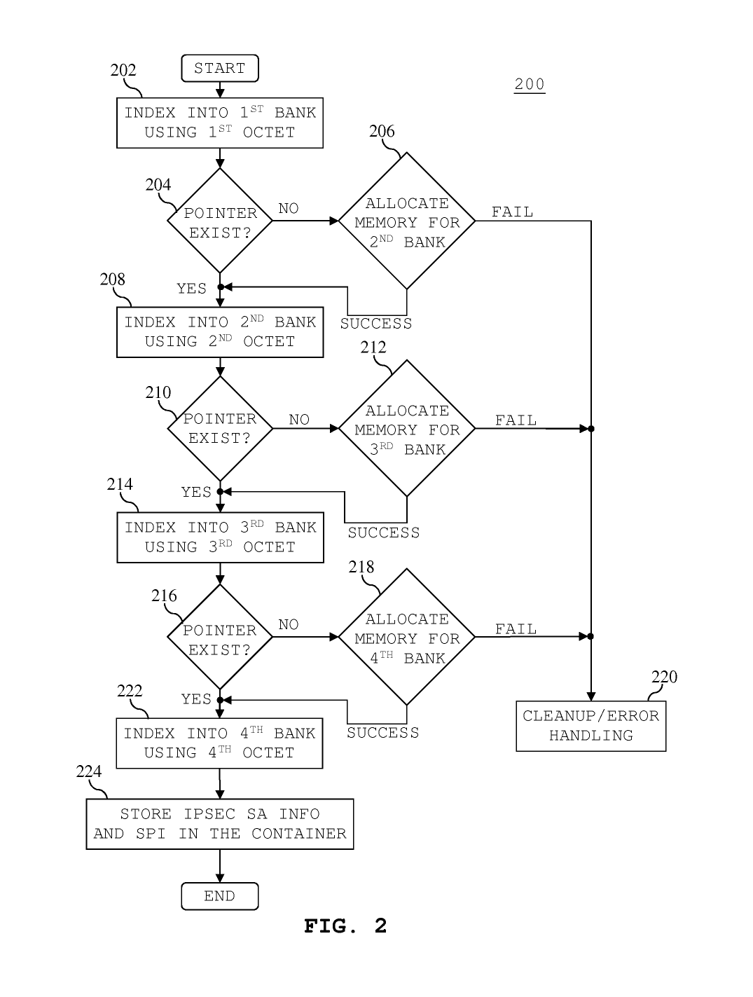

Before the IPsec security association information for a particular IPv4 address can be retrieved using this technique, the different memory banks used for retrieving the IPsec security information are first allocated. According to some embodiments of the present invention, the different memory banks can be allocated before any IPsec security associations are stored (e.g., at a factory or some time before or during the setup of the security gateway). According to other embodiments of the present invention (e.g., FIG. 2), the different memory banks can be allocated on an as-needed basis, as the IPsec security associations are established.

Thus, it will be understood that certain embodiments of the present invention(s) are directed to storing IPsec security association information using IP addresses, while other embodiments of the present invention(s) are directed to retrieving IPsec security association information using IP addresses. Further, it will be understood that embodiments of the present invention are not limited to storing and retrieving IPsec security association information. Alternative embodiments of the present invention may store and retrieve information other than IPsec security association information using IP addresses.

One embodiment of the present invention(s) is a method for storing information in a memory using an IP address comprising a plurality of numerical fields. In the method, penultimate and ultimate memory banks for the IP address are allocated from the memory. A penultimate pointer is stored in a location of the penultimate memory bank indexed by the value of a penultimate numerical field in the IP address, wherein the penultimate pointer points to the ultimate memory bank. Further, the information is stored in a location of the ultimate memory bank indexed by the value of an ultimate numerical field in the IP address.

Another embodiment of the present invention(s) is a security gateway comprising a memory for storing information using an IP address comprising a plurality of numerical fields. The security gateway memory comprises a penultimate memory bank for the IP address and an ultimate memory bank for the IP address. The penultimate memory bank stores a penultimate pointer in a location of the penultimate memory bank indexed by the value of a penultimate numerical field in the IP address, where the penultimate pointer points to the ultimate memory bank. The ultimate memory bank stores the information in a location of the ultimate memory bank indexed by the value of an ultimate numerical field in the IP address.

Yet another embodiment of the present invention is a method for retrieving information in a memory using an IP address comprising a plurality of numerical fields. The memory comprises a penultimate memory bank for the IP address and an ultimate memory bank for the IP address. In the method, the value of a penultimate numerical field in the IP address is used to index into the penultimate memory bank to obtain a penultimate pointer stored in the penultimate memory bank. The penultimate pointer, which points to the ultimate memory bank, is followed to the ultimate memory bank, and the value of an ultimate numerical field in the IP address is used to index into the ultimate memory bank to retrieve the information stored in the ultimate memory bank.

FIG. 2 shows a simplified flow diagram of processing 200 that may be performed by a security gateway to store IPv4 IPsec security association information according to one embodiment of the present invention. Processing 200 may be implemented by a controller of a security gateway of a smaller network, such as a controller (not shown) of the virtual private network (VPN) 100 shown in FIG. 1, or by controllers of security gateways of larger networks, such as those implemented by enterprises or carriers.

In general, the security gateway performs processing 200 each time a new IPsec security association is established. For a particular IPsec security association, the security gateway performs processing 200 to store, in memory, IPsec security association information such as (i) a pointer to the IPsec security association, where the IPsec security association is stored elsewhere in memory, or (ii) the IPsec security association itself. The location of the IP security association information is identified using four memory banks, where each memory bank corresponds to a different octet of the corresponding IPv4 address.

Each memory bank is a linear memory that is allocated from a larger memory of the security gateway. Each memory bank stores up to 256 different elements, one element for each of the 256 values that can be represented in an octet (i.e., 0, 1, . . . , 255). Further, each element is initialized to zero and is configured to store a pointer. Note that, in some embodiments, the last memory bank may be configured to store the IPsec security association itself, rather than a pointer to the IPsec security association. The size of each pointer may be, for example, four bytes for a 32-bit CPU architecture or eight bytes for a 64-bit CPU architecture.

Before information for any IPsec security associations is stored (i.e., before process 200 is performed for the first time), an initialization step is performed (not shown) in which a first memory bank of the security gateway memory is allocated. The first memory bank corresponds to the first octet position of an IPv4 address.

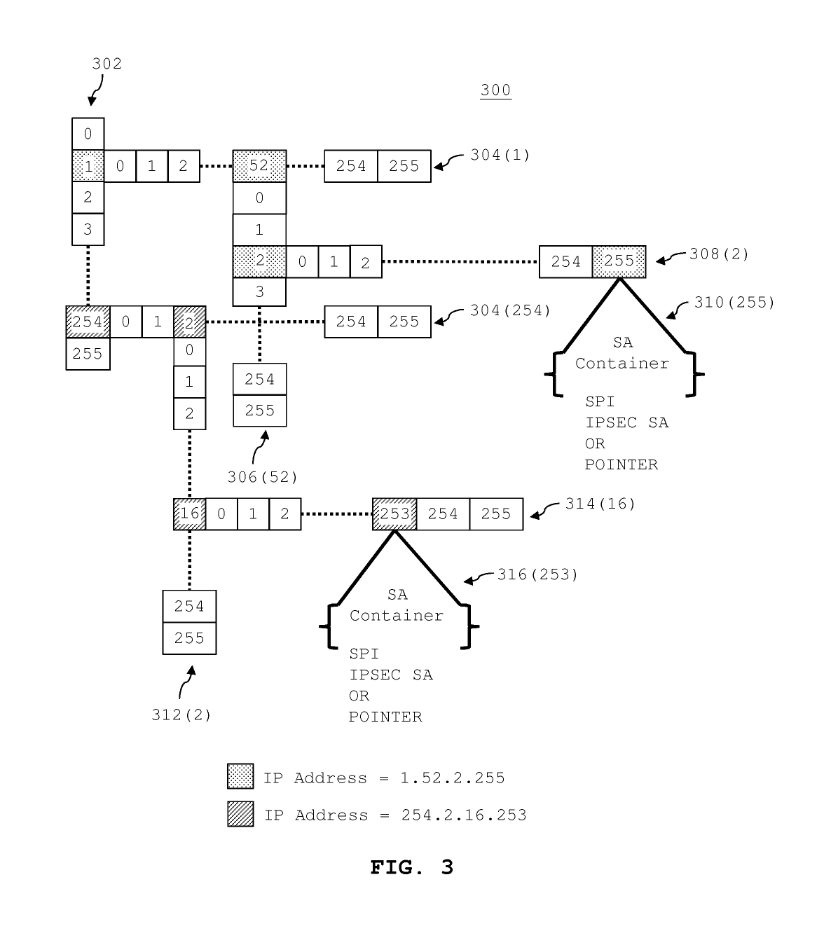

Upon starting process 200 for a new IPsec security association, the value of the first octet of the corresponding IP address is used to index into the first memory bank in step 202. To further understand the operation of the flow diagram 200, consider FIG. 3.

FIG. 3 shows a simplified representation of a memory 300 of a security gateway according to one embodiment of the present invention. The security gateway memory 300 comprises seven memory banks 302, 304(1), 304(254), 306(52), 308(2), 312(2), and 314(16). As will be discussed in further detail below, the memory banks are logically arranged in FIG. 3 to facilitate the understanding of process 200. This arrangement does not depict the actual physical arrangement of the security gateway memory 300.

The memory banks shown are for two exemplary IP addresses (i.e., 1.52.2.255 and 254.2.16.253); however, the security gateway memory 300 may have additional memory banks for storing information for as many as 256^{̂4} unique IPsec security associations, one IPsec security association for each of the possible 256^{̂4} IPv4 addresses. To store IPsec security association information for the first exemplary IP address (i.e., 1.52.2.255), the value of the first octet of the IP address (i.e., 1) is used in step 202 to index into a first memory bank 302 of the security gateway memory 300. The first memory bank 302 is allocated during an initialization step, prior to performing processing 200, as described above.

In step 204, a determination is made as to whether or not a pointer is stored in position “1” of the first memory bank 302. If no pointer is stored, then, in step 206, the security gateway (i) allocates a second memory bank 304(1) of the security gateway memory 300, wherein the second memory bank 304(1) corresponds to the second octet of the IP address, and (ii) stores a pointer in position “1” of the first memory bank 302 that points to the second memory bank 304(1).

If, on the other hand, it is determined in step 204 that there is a pointer stored in position “1” of the first memory bank 302 (or after a pointer is stored in position “1” of the first memory bank 302 in step 206), then, in step 208, the security gateway (i) follows the pointer at position “1” of the first memory bank 302 to the second memory bank 304(1), and (ii) uses the value of the second octet of the IP address (i.e., 52) to index into the second memory bank 304(1).

In general, the first time that a position of one of the first, second, and third memory banks is indexed, a new memory bank is allocated and a new pointer is stored that points to the new memory bank. Once a memory bank has been allocated and a pointer stored for that memory bank, that memory bank can be used for other IP addresses. For example, after allocating the second memory bank 304(1) for IP address 1.52.2.255, the second memory bank 304(1) can be used in subsequent iterations of process 200 for other IP addresses having a first octet value of “1” (i.e., 1.b.c.d). Thus, for subsequent IP addresses beginning with a value of “1”, the security gateway will (i) determine in step 204 that there is a pointer at position “1” of the first memory bank 302, and (ii) index into the second memory bank 304(1) in step 208 using the second octet of the subsequent IP address, without performing step 206.

Note that, in FIG. 3, some memory banks appear to extend from positions of other memory banks. For example, the second memory bank 304(1) appears to extend from position “1” of the first memory bank 302. It will be understood that this arrangement merely indicates that a position in a memory bank points to another memory bank. In a real-world implementation, where the memory banks are allocated from, for example, a two-dimensional memory array of a security gateway, the memory banks typically will not extend from other memory banks. Rather, each memory bank will occupy a separate part of the security gateway memory 300, and will be accessed using pointers.

In step 210, a determination is made as to whether or not a pointer is stored in position “52” of the memory bank 304(1). If no pointer is stored, then, in step 212, the security gateway (i) allocates a third memory bank 306(52) of the security gateway memory 300, wherein the third bank 306(52) corresponds to the third octet of the IP address, and (ii) stores a pointer in position “52” of the second memory bank 304(1) that points to the third memory bank 306(52). If, instead, in step 210, it is determined that there is a pointer stored in position “52” of memory bank 304(1) (or after a pointer is stored in position “52” of memory bank 304(1) in step 212), then, in step 214, the security gateway (i) follows the pointer at position “52” of the second memory bank 304(1) to the third memory bank 306(52), and (ii) uses the value of the third octet of the IP address (i.e., 2) to index into the third memory bank 306(52).

In step 216, a determination is made as to whether or not a pointer is stored in position “2” of the memory bank 306(52). If no pointer is stored, then, in step 218, the security gateway (i) allocates a fourth memory bank 308(2) of the security gateway memory 300, wherein the fourth bank 308(2) corresponds to the fourth octet of the IP address, and (ii) stores a pointer in position “2” of the third memory bank 306(52) that points to the fourth memory bank 308(2). If, instead, in step 216, it is determined that there is a pointer stored in position “2” of the third memory bank 306(52) (or after a pointer is stored in position “2” of the third memory bank 306(52) in step 218), then, in step 222, the security gateway (i) follows the pointer at position “2” of the third memory bank 306(52) to the fourth memory bank 308(2), and (ii) uses the value of the fourth octet of the IP address (i.e., 255) to index into the fourth memory bank 308(2).

Each element of the fourth memory bank 308(2) is a container that is configured (e.g., sized) to store IPsec security association information and, optionally, a security parameter index (SPI). In step 224, the security gateway stores the IPsec security association information and, optionally, a corresponding SPI in the container 310(255). The IPsec security association information may be a pointer that points to the location where the IPsec security association is stored in the security gateway memory 300. In such a case, the IPsec security association itself may be stored in the security gateway memory 300 some time prior to performing step 224, and step 224 may merely store a pointer to the location where the IPsec security association was previously stored. Alternatively, the IPsec security association information may be the IPsec security association itself, and step 224 may store the IPsec security association in container 310(255).

If, during the performance of steps 206, 212, or 218, the allocation of a memory bank fails (e.g., due to insufficient memory being available), then cleanup and error handling 220 may be performed to, for example, free up previously allocated memory banks.

In the second exemplary IP address (i.e., 254.2.16.253) shown in FIG. 3, IPsec security association information (e.g., a pointer to an IPsec security association or the IPsec security association itself) is stored by performing process 200 in a manner similar to that described above. Note, however, that the second through fourth memory banks 304(254), 312(2), and 314(16), and the container 316(253) used in the second example are different from the second through fourth memory banks 304(1), 306(52), and 308(2) and the container 310(255) used in the first example, respectively.

The amount of memory needed to store IPsec security associations for all 256^{̂4} possible IPv4 addresses can be relatively large. However, typical security gateways do not employ all 256^{̂4} possible IP addresses. Therefore, memory banks need not be allocated for all 256^{̂4} possible IP addresses.

In addition, in some cases, it might be known that fewer than all 256 possible values of an octet will be employed. In such cases, memory banks having fewer than 256 elements may be allocated for the octet. For example, if a security gateway supports the public IP address range (i.e., 224.0.0.0 to 239.255.255.255), then the first memory bank can comprise only 16 elements, one for each possible value of the first octet in the public IP address range (i.e., 224 to 239), rather than all 256 possible elements.

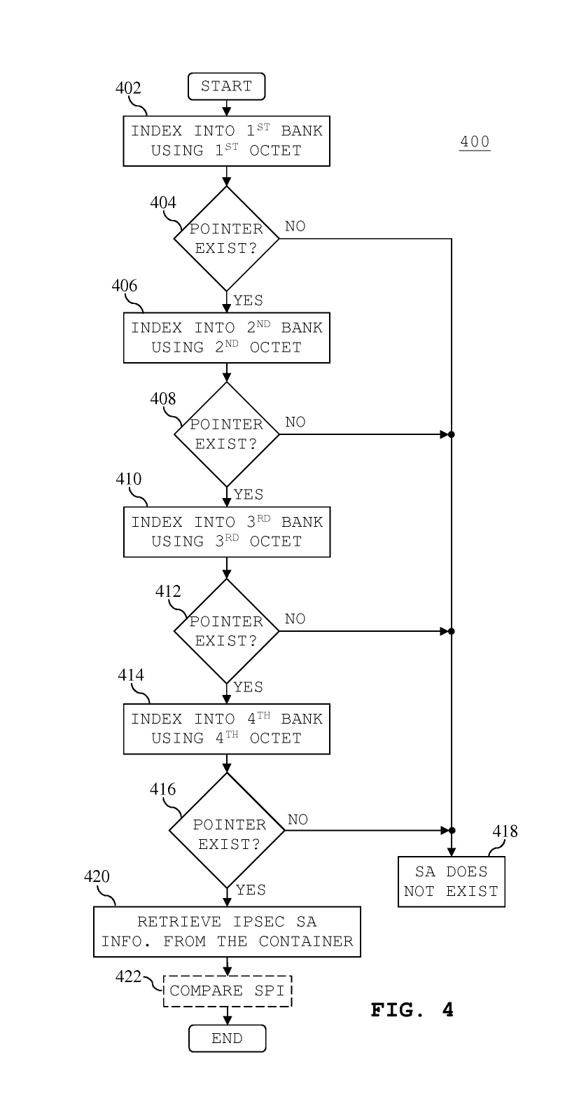

FIG. 4 shows a simplified flow diagram of processing 400 that may be performed by a security gateway to retrieve IPsec security association information according to one embodiment of the present invention. Processing 400 may be implemented by a controller of a security gateway of a smaller network, such as a controller (not shown) of the virtual private network (VPN) 100 shown in FIG. 1, or by controllers of security gateways of larger networks, such as those implemented by enterprises or carriers. Further, the security gateway performs processing 400 each time that an IPsec security association is to be retrieved. To further understand processing 400, consider the first exemplary IP address (i.e., 1.52.2.255) stored in the security gateway memory 300 of FIG. 3.

Prior to step 402, the administrator may input the IPv4 address (in this case 1.52.2.255), and optionally an SPI, to be searched. In step 402, the security gateway uses the first octet (i.e., “1”) to index into the first memory bank 302, and in step 404, the security gateway determines whether or not a pointer is stored at position “1” of the first memory bank 302. If a pointer is stored at position “1”, then, in step 406, the security gateway (i) follows the pointer at position “1” of the first memory bank 302 to the second memory bank 304(1), and (ii) uses the value of the second octet of the IP address (i.e., 52) to index into the second memory bank 304(1).

In step 408, the security gateway determines whether or not a pointer is stored at position “52” of the second memory bank 304(1). If a pointer is stored at position “52”, then, in step 410, the security gateway (i) follows the pointer at position “52” of the second memory bank 304(1) to the third memory bank 306(52), and (ii) uses the value of the third octet of the IP address (i.e., 2) to index into the third memory bank 306(52).

In step 412, the security gateway determines whether or not a pointer is stored at position “2” of the third memory bank 306(52). If a pointer is stored at position “2”, then, in step 414, the security gateway (i) follows the pointer at position “2” of the third memory bank 306(52) to the fourth memory bank 308(2), and (ii) uses the value of the fourth octet of the IP address (i.e., 255) to index into the fourth memory bank 308(2).

In step 416, the security gateway determines whether or not IPsec security association information is stored in the container 310(255) at position “255” of the fourth memory bank 308(2). If IPsec security association is stored at position “255”, then, in step 420, the security gateway uses this pointer to retrieve the IPsec security association information from the security gateway memory 300. Note that, if in any of steps 404, 408, 412, and 416, the security gateway determines that IPsec security association information is not stored in the corresponding memory bank, then the security gateway determines that an IPsec security association does not exist for the IP address (decision 418).

Upon retrieving the IPsec security association information, the security gateway may perform optional step 422 to validate the correctness of the IPsec security association by comparing the SPI input by the administrator to the SPI (if any) stored in the container 310(255).

As used herein, the term “ultimate,” when used in conjunction with (i) the term “numerical field” refers to the last numerical field used as an index for a particular IP address and (ii) the term “memory bank” refers to the last memory bank allocated for a particular IP address, not the last memory bank in the security gateway memory. Further, the terms “penultimate,” “antepenultimate,” and “preantepenultimate,” when used in conjunction with the term “numerical field,” refer, respectively, to the next to last, third to last, and fourth to last numerical fields used as an index for a particular IP address. When used in conjunction with the term “memory bank,” those terms refer, respectively, to the next to last, third to last, and fourth to last memory banks allocated for a particular IP address, not the next to last, third to last, and fourth to last memory banks in the security gateway memory.

Although embodiments of the present invention(s) were described as being implemented using IPv4, embodiments of the invention(s) are not so limited. According to alternative embodiments, the present invention(s) can be implemented using IP protocols other than IPv4. For example, alternative embodiments of the present invention(s) may be implemented using Internet Protocol version six (IPv6). In IPv6, the addresses may be represented as eight numerical fields of four hexadecimal digits separated by colons (e.g., 2001:0db8:85a3:0042:1000:8a2e:0370:7334). In such embodiments, as many as eight memory banks, one for each numerical field, may be used for each IPv6 address to store IPsec security association information.

Further, although an embodiment of the present invention was described as being used to store and retrieve IPsec security association information, embodiments of the present invention are not so limited. According to alternative embodiments, the present invention may be used to store and retrieve information other than IPsec security association information, including (without limitation) accounting information used in Remote Authentication Dial In User Service (RADIUS).

Yet further, although embodiments of the present invention(s) were described as allocating memory banks and indexing into the memory banks using octets of an IPv4 address, in order from the left-most octet to the right-most octet, embodiments of the present invention(s) are not so limited. According to alternative embodiments of the present invention(s), the memory banks may be allocated and indexed into using the octets in an order than that described. For example, the memory banks could be allocated and indexed in order of the right-most octet to the left-most octet. For instance, memory 300 in FIG. 3 could be implemented such that the first memory bank 302 allocated and indexed corresponds to the right-most octet, rather than the left-most octet, of an IP address. In such a case, the left-most octet serves as the ultimate numerical field and the right-most octet serves as the preantepenultimate numerical field.

According to alternative embodiments of the present invention, IPsec security association information may be stored using fewer memory banks than the number of octets. For example, if it is known that a particular gateway will only use IP addresses in which the first octet has a value of 224 (i.e., 224.b.c.d), then a separate memory bank for the first octet can be avoided. In such a case, the IPsec security association information would be stored using the second through fourth octets of the IP address and not the first octet.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

1. A method for storing information in a memory using an Internet Protocol (IP) address comprising a plurality of numerical fields, the method comprising:
(a) allocating, from the memory, a penultimate memory bank for the IP address;
(b) allocating, from the memory, an ultimate memory bank for the IP address;
(c) storing a penultimate pointer in a location of the penultimate memory bank indexed by the value of a penultimate numerical field in the IP address, wherein the penultimate pointer points to the ultimate memory bank; and
(d) storing the information in a location of the ultimate memory bank indexed by the value of an ultimate numerical field in the IP address.

2. The method of claim 1, further comprising:
(e) allocating, from the memory, an antepenultimate memory bank for the IP address; and
(f) storing an antepenultimate pointer in a location of the antepenultimate memory bank indexed by the value of an antepenultimate numerical field in the IP address, wherein the antepenultimate pointer points to the penultimate memory bank.

3. The method of claim 1, wherein the IP address is an IP version four (IPv4) address.

4. The method of claim 1, wherein step (a) comprises:
(a1) indexing into a location of an antepenultimate memory bank using the value of an antepenultimate numerical field of the IP address;
(a2) determining that an antepenultimate pointer is not stored in the location of the antepenultimate memory bank;
(a3) allocating the penultimate memory bank; and
(a4) storing, in the location of the antepenultimate memory bank, an antepenultimate pointer that points to the penultimate memory bank.

5. The method of claim 1, wherein step (b) comprises:
(b1) indexing into a location of the penultimate memory bank using the value of the penultimate numerical field of the IP address;
(b2) determining that a penultimate pointer is not stored in the location of the penultimate memory bank; and
(b3) allocating the ultimate memory bank.

6. The method of claim 1, wherein step (d) comprises:
(d1) indexing into the location of the ultimate memory bank using the value of the ultimate numerical field of the IP address; and
(d2) storing, in the location of the ultimate memory bank, the information.

7. The method of claim 1, wherein the information comprises one of (i) a pointer to an IPsec security association (SA) stored in memory and (ii) the IPsec SA.

8. The method of claim 7, wherein step (d) further comprises storing a security parameter index (SPI) in the location of the ultimate memory bank indexed by the value of the ultimate numerical field in the IP address.

9. A security gateway comprising a memory for storing information using an Internet Protocol (IP) address comprising a plurality of numerical fields, the memory comprising:
a penultimate memory bank for the IP address; and
an ultimate memory bank for the IP address, wherein:
the penultimate memory bank stores a penultimate pointer in a location of the penultimate memory bank indexed by the value of a penultimate numerical field in the IP address, wherein the penultimate pointer points to the ultimate memory bank; and
the ultimate memory bank stores the information in a location of the ultimate memory bank indexed by the value of an ultimate numerical field in the IP address.

10. The security gateway of claim 9, further comprising a controller configured to:
(a) allocate the penultimate memory bank;
(b) allocate the ultimate memory bank;
(c) store the penultimate pointer in the location of the penultimate memory bank indexed by the value of the penultimate numerical field in the IP address; and
(d) store the information in the location of the ultimate memory bank indexed by the value of the ultimate numerical field in the IP address.

11. The security gateway of claim 10, wherein the controller is further configured to:
(e) index into the penultimate memory bank using the value of the penultimate numerical field in the IP address to obtain the penultimate pointer stored in the penultimate memory bank;
(f) follow the penultimate pointer to the ultimate memory bank;
(g) index into the ultimate memory bank using the value of the ultimate numerical field in the IP address to retrieve the information stored in the ultimate memory bank.

12. The security gateway of claim 9, further comprising a controller configured to:
(a) index into the penultimate memory bank using the value of the penultimate numerical field in the IP address to obtain the penultimate pointer stored in the penultimate memory bank;
(b) follow the penultimate pointer to the ultimate memory bank;
(c) index into the ultimate memory bank using the value of the ultimate numerical field in the IP address to retrieve the information stored in the ultimate memory bank.

13. The security gateway of claim 9, further comprising an antepenultimate memory bank that stores an antepenultimate pointer in a location of the antepenultimate memory bank indexed by the value of an antepenultimate numerical field in the IP address, wherein the antepenultimate pointer points to the penultimate memory bank.

14. The security gateway of claim 9, wherein the information comprises one of (i) a pointer to an IPsec security association (SA) stored in memory and (ii) the IPsec SA.

15. The security gateway of claim 14, wherein:
the ultimate memory bank stores a security parameter index (SPI) in the location of the ultimate memory bank indexed by the value of the ultimate numerical field in the IP address; and
the security gateway comprises a controller configured to compare the stored SPI to an SPI provided by an administrator.

16. A method for retrieving information in a memory using an Internet Protocol (IP) address comprising a plurality of numerical fields, wherein the memory comprises a penultimate memory bank for the IP address and an ultimate memory bank for the IP address, the method comprising:
(a) indexing into the penultimate memory bank using the value of a penultimate numerical field in the IP address to obtain a penultimate pointer stored in the penultimate memory bank, wherein the penultimate pointer points to the ultimate memory bank;
(b) following the penultimate pointer to the ultimate memory bank;
(c) indexing into the ultimate memory bank using the value of an ultimate numerical field in the IP address to retrieve the information stored in the ultimate memory bank.

17. The method of claim 16, wherein:
the memory further comprises an antepenultimate memory bank for the IP address; and
the method comprises, before step (a):
(1) indexing into the antepenultimate memory bank using the value of an antepenultimate numerical field in the IP address to obtain an antepenultimate pointer stored in the antepenultimate memory bank, wherein the antepenultimate pointer points to the penultimate memory bank; and
(2) following the antepenultimate pointer to the penultimate memory bank.

18. The method of claim 16, wherein the IP address is an IP version four (IPv4) address.

19. The method of claim 16, wherein the information comprises one of (i) a pointer to an IPsec security association (SA) stored in memory and (ii) the IPsec SA.

20. The method of claim 19, wherein:
step (c) further comprises retrieving a security parameter index (SPI) stored in the ultimate memory bank; and
the method further comprises (d) comparing the stored SPI to an SPI provided by an administrator.
